(19) United States
(12) Patent Application Publication
(10) Pub. No.: US 2005/0001791 A1
(43) Pub. Date: Jan. 6, 2005

(54) Front panel with system information

(76) Inventor: Stan Cheng, Taipei (TW)

Correspondence Address: FENWICK & WEST LLP, SILICON VALLEY CENTER, 801 CALIFORNIA STREET, MOUNTAIN VIEW, CA, 94041, US

(21) Appl. No.: 10/759,761

(22) Filed: Jan. 16, 2004

(30) Foreign Application Priority Data
Jan. 17, 2003 (TW) 092200873

(51) Int. Cl. G09G 3/00

(52) U.S. Cl. 345/30

(57) ABSTRACT

An information display panel for a computer displays the operational status of the CPU and the BIOS, information processed by the operation system, information processed by a remote computer through a USB port, and/or a clock with alarm function. Moreover, the display panel may display such information when the computer is powered down.

### CROSS REFERENCE TO RELATED APPLICATIONS

This application claims the right of priority based on Taiwan application serial no. 092200873, filed on Jan. 17, 2003, which is herein incorporated in its entirety by reference.

### BACKGROUND

1. Field of the Invention

The invention relates to computers and computer chassis design, and in particular to computers with display panels for showing information processed by the computer system and/or information received from remote systems.

### BACKGROUND OF THE INVENTION

With the development of computing technology, computers offer more powerful processing capabilities at lower cost. While the design of computers continues to advance, computers lack the capability to display the status of the computer, such as by means of the BIOS, or have poor such capabilities. Early computers, such as those using the P486 microprocessor, were equipped with seven-segment displays on the chassis to show the CPU clock; however, such displays were turned off when the computers were powered down. Moreover, computers that were able to output information to a display panel did so through a serial port, such as a RS-232 port, or a parallel port, such as a printer port. Therefore, there is a need for a computer information panel that receives information at high speed (for example, by a USB port), captures and displays the operating status of the computer by means of the BIOS, and displays a clock after the computer is powered down.

### SUMMARY OF THE INVENTION

Accordingly, the present invention enables a computer information panel that can display information such as the operating status of the CPU and the BIOS and/or other information processed by the operating system of the computer or from a remote computer. In one embodiment, the information is transferred to the display panel through a USB port, offering high speed. In another embodiment, the display panel includes a clock and/or alarm function at least when the computer is powered down.

In one embodiment, a computer information panel connected to a computer chassis is communicatively coupled to a USB port of a computer for displaying status information about the computer or other information from one or more remote computers. The display panel includes an computer that receives and outputs the status information about the computer or the information processed by the remote computer. The display panel further includes a display unit connected to the computer that displays the status information received by the computer. In alternative embodiments, the display panel includes a clock functionality with an alarm, which can be set using an alarm set/reset button when the computer is powered on and the display unit displays a clock.

### BRIEF DESCRIPTION OF THE DRAWINGS

FIG. 1 illustrates a front panel of a computer chassis showing a display panel, in accordance with an embodiment of the invention.

FIG. 2 is a schematic diagram of a computer motherboard and relevant components for the display panel, in accordance with an embodiment of the invention.

### DETAILED DESCRIPTION OF THE PREFERRED EMBODIMENTS

An information display panel for a computer displays the operational status of the CPU and the BIOS, information processed by the operation system, information processed by a remote computer through a USB port, and/or a clock with an alarm function. Moreover, the display panel may display the time and alarm information when the computer is powered down. In one embodiment of the invention, the computer information display panel shows status information about the computer system and that processed by the operation system. In another embodiment, the computer information display panel receives and displays information from remote computers. The display unit can receive such information through a USB port.

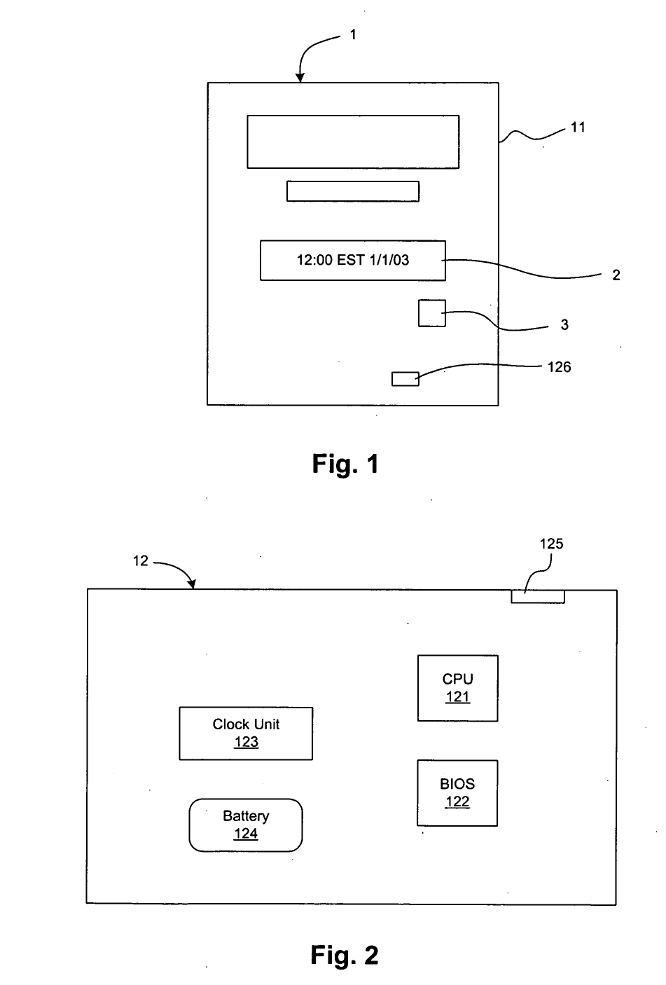

FIG. 1 illustrates one physical configuration of the computer information display panel 1 in accordance with the present invention. The display panel 1 forms a front panel of a computer chassis 11 and includes a display unit 2 and an alarm set/reset button 3. The display unit 2 and the alarm set/reset button 3 can be attached to the chassis 11 of the computer, preferably on a front panel thereof so that the display is visible to a user during typical operation. The display unit 2 can be an LCD, an LED display, or any other suitable display. The front panel 11 of the computer 1 also includes a USB port 126. Other physical configurations of the computer are possible without departing from the inventive concepts herein.

The computer further includes a motherboard 12, a schematic of which is shown in FIG. 2. The motherboard 12 includes a CPU 121, a BIOS 122, a clock unit 123, a battery 124, and a USB port 125. The display panel 1 is connected to the motherboard 1 by USB ports 126 and 125, and in this way, the display panel 1 can receive information to display on the display unit 2. The operating system, which runs on CPU 121, includes a driver and appropriate software modules to enable the USB 125 to receive and send information and to set the display unit 2 to show that information.

The CPU 121 controls the operation of the computer and outputs its operating status information, such as operating temperature and speed of rotation of the cooling fan, to the display unit 2. The BIOS 122 processes inputs and outputs of the motherboard 11 and records and sends operating status information on the CPU 121 to the display unit 2. The clock unit 123 communicates with the display unit 2 for providing time information, for example when the computer is powered down. The clock unit 123 receives power from the cell 124 when the computer is turned off. The USB port 125 is connected to the USB port 126 on the computer for information transmission.

In one embodiment, the display unit 2 displays first-hand information about the CPU 121 and the BIOS 122, processed for example by an operating system running on the CPU 121. The CPU 121 and the BOIS 122 are configured to generate first-hand information about the operation of the computer 1. Such first-hand information may include the clock speed of the CPU 121, the operating temperature of various locations inside the computer 1, the speed of rotation of a cooling fan in the computer 1, and/or the versions and settings of the BOIS 122. The CPU 121 and the BIOS 122 are coupled to provide this information to the display unit 2, which display the information.

In another embodiment, the display unit 2 displays second-hand information that is processed by a remote system. The display unit receives this second-hand information from a remote unit through a USB port 126 in the computer 1.

Accordingly, the computer information display panel 1 of this design can display several types of information on the display unit 2. In one example, the computer information display panel 1 displays status information about the computer, for example that received by the BOIS 122. The status information includes the model, operating frequency, the temperature of the CPU 121, and the speed of rotation of the cooling fan. Such information may be useful for calling the user's attention to any undesirable operating conditions. In another example, the panel 1 displays the models (e.g., IDE or SCSI) and capabilities of the hard disks connected to the computer.

In another example, the display unit 2 displays operational information about the computer processed by the operating system and the display unit driver. Such information may include diagnostic and performance information that is measurable with software on the computer. The operating system can send this information to the display panel 1 through the USB ports 125 and 126. In another embodiment, the display unit 2 displays second-hand information, such as advertisement messages received from remote computer systems. Like the diagnostic information, these types of messages are processed by the operating system icon and are sent to the display unit 2 through the USB ports 125 and 126.

In another embodiment, the display unit 2 receives time information from the clock unit 123. Because the clock unit 123 is powered by the battery 124 when the computer is powered down, the clock unit 123 can operate at all times. As above, the clock unit 123 can communicate to the display unit 2 through the USB ports 125 and 126. Even while the computer is powered down, the clock unit 1 can provide alarm clock functionality, which can be adjusted and invoked using the alarm set/reset button 3.

The foregoing description of the embodiments of the invention has been presented for the purposes of illustration and description. It is not intended to be exhaustive or to limit the invention to the precise forms disclosed. Persons skilled in the relevant art can appreciate that many modifications and variations are possible in light of the above teaching. It is therefore intended that the scope of the invention be limited not by this detailed description, but rather by the claims appended hereto.

1. A computer information display panel for displaying information on a computer, the display panel comprising:
a USB interface;
a processor configured to output operational information about the computer system when the computer is powered on;
a display unit coupled to the processor via the USB interface, the display unit configured to display the information; and
a clock unit coupled to the display unit, the clock unit being powered separately from the computer to provide time information to the display unit when the computer is powered down, the display unit displaying the time information.

2. The display panel of claim 1, wherein the clock unit includes an alarm function.

3. The display panel of claim 1, wherein the processor is a central processing unit of a computer, and the processor computes the operational information by communicating with the BIOS.

4. The display panel of claim 1, wherein the processor is further coupled to one or more remote computer systems for receiving secondary information therefrom, the processor configured to communicate that information to the display unit.

5. The display panel of claim 1, wherein the secondary information received from the remote computer system is advertising information.

6. The display panel of claim 1, wherein the display unit is selected from a group consisting of: an LCD and an LED display.

7. The display panel of claim 1, wherein the operational information includes information selected from a group consisting of: computer model, status information on the BIOS, CPU clock rate, operating temperature, and hard disk data.
